(19) United States
(12) Patent Application Publication
(10) Pub. No.: US 2002/0192138 A1
(43) Pub. Date: Dec. 19, 2002

(54) Process for producing finely divided metal oxides

(76) Inventor: William A. Yuill, Edmond, OK (US)

Correspondence Address: McAfee & Taft, Two Leadership Square, Tenth Floor, 211 N. Robinson, Oklahoma City, OK, 73102, US

(21) Appl. No.: 09/885,891

(22) Filed: Jun. 19, 2001

(51) Int. Cl. B32B 5/16; C01B 13/20

(52) U.S. Cl. 423/337; 428/402; 428/403; 423/592; 423/610; 423/625

(57) ABSTRACT

A process for continuously preparing finely divided refractory oxides having a particle specific surface area of less than about 100 m²/g from an oxygen containing reactant gas and at least one reactant selected from the group consisting of vaporous salts of silicon, titanium, aluminum, zirconium, iron and antimony, wherein at least one of the reactant materials is heated by means of a plasma generator which produces a temperature in the range of from about 3,000°-to about 12,000° C., and the reactants are combined and passed into a reaction zone for a period of from about 0.001 to about 1.0 second to give the oxide product. The oxygen-containing gas stream comprises from about 100 to about 105% of the stoichiometric amount of oxygen based on the vaporous salt and from about 10 to about 150%, based on oxygen, of a gaseous diluent which is inert under reaction conditions. A quench gas is injected into the oxide product stream after said stream exits the reaction zone and before any substantial cooling of said stream occurs.

### BACKGROUND OF THE INVENTION

1. Field of the Invention

This invention relates generally to an improved plasma jet process for making finely divided oxides of refractory metals and metalloids. More particularly, it relates to a high temperature plasma jet process for producing finely divided titanium dioxide.

2. Description of the Prior Art

It is well known to make refractory metal and metalloid oxides by various methods. One method used to produce titanium dioxide, but also applicable to other metal oxides by appropriate changes in reactants and conditions, involves the digestion of titaniferous ore material with sulfuric acid to produce titanium sulfate. The titanium sulfate is calcined if it is desired to produce a pigment grade titanium dioxide. The product obtained from this method is TiO₂ of a wide range of particle sizes. It is often necessary to subject the product to further treatment if it is desired to improve its quality for pigment application.

Another known method of producing metal oxides such as silicon dioxide or titanium dioxide is to react the metal chloride with oxygen at an elevated temperature. In this method, the reactants are brought to reaction temperatures by burning an intimately mixed flammable gas such as methane or propane. The reaction products of burning the flammable gas including water are present during the metal chloride-oxygen reaction. Water does not interfere with the reaction, but has an impact on overall reaction efficiency. That is, the water affects the formation of pigmentary metal oxide by making the particles more aggregated or agglomerated. More importantly, the water reacts with chlorine to form hydrochloric acid which condenses when the reaction products are cooled and corrodes metal surfaces. Prior to recycling the chlorine in the reactor effluent to produce more metal chloride for oxidization, water in the effluent must be removed. This necessitates either a fractionation step with its cumbersome and expensive apparatus or other separating means. As mentioned, if the water is not removed, the chlorine reacts with it to produce hydrochloric acid, thus leading to the disadvantages of loss of valuable chlorine, introduction of a severe corrosion problems, and disposal requirements for the hydrochloric acid.

Normally, metal oxide powders obtained from known oxidation processes such as those described above tend to have a preponderance of large particles. For pigmentary, filling, weighing and reinforcing applications, it is desirable to have a smaller and more uniform metal oxide particle size. This objective can be accomplished by the addition to the reaction mixture of a significant amount of a material such as aluminum chloride which performs a nucleating function. While the contamination introduced for purposes of increasing nucleation is not undesirable, the addition of the nucleating agent involves an added production cost which is, of course, of critical concern in large-scale commercial operations.

Recently, a method has been disclosed which overcomes many of the disadvantages associated with known methods of producing finely divided oxides. It was found that oxide powders, particularly titanium dioxide, could be produced without utilization of an auxiliary burning gas and with reduced or minimal amounts of nucleating agents by oxidizing a metal salt with a plasma jet generator. In this method, a gas is passed through a high energy electric arc or field, either DC or radio frequency, and the resulting plasma is brought into contact with a gas stream to be oxidized comprised of a metal salt and oxygen. The term “plasma” is used herein to designate a very hot, partially ionized gas stream. The plasma is the source of heat for raising the metal salt and oxygen reactants to a temperature at which oxidation is initiated. No gas burning reaction products are introduced into the gas stream and, thus, the above described problems associated with the prior art methods are obviated. Moreover, in view of the much higher temperatures which are attainable by the plasma jet method, nucleation is much more general even without an added nucleating agent.

The general procedure employed in utilizing the plasma jet involves heating a gas such as nitrogen, argon, air, oxygen, etc., by means of a DC arc or radio frequency torch to form a hot plasma stream. The reactants are brought into intimate contact with the plasma stream in a manner such that the desired exothermic oxidation reaction is initiated. The resultant metal oxide product is secured by quenching the reactor effluent and entrapping by conventional means the precipitated metal oxide powder.

This method is useful for the production of many kinds of refractory metal or metalloid oxides or mixtures of such oxides. The metal or metalloid salts which can be oxidized are exemplified by silicon, titanium, aluminum, zirconium, iron and antimony compounds although not limited thereto. It is also feasible to use mixtures of such salts. Most important of the oxidizable compounds which can be converted by the plasma jet oxidation process are silicon tetrahalide and titanium tetrahalide. These materials give oxide powders which are widely used in pigment, rubber and paper applications.

In plasma jet processes for production of metal and metalloid oxides, particle size can be controlled by using large excesses of oxygen over stoichiometry. The difficulty with using large excesses of oxygen is that pure oxygen is expensive and its use adds to the cost of the product.

Thus, there is a need for a plasma jet process for the production of finely divided metal oxides without the necessity of using large excesses of oxygen. More particularly, there is a need for an improved plasma jet process for producing finely divided metal oxides which are substantially spherical in shape, substantially transparent to visible light and substantially absorbent to UV light.

### SUMMARY OF THE INVENTION

The present invention provides an improved plasma jet process for producing ultra-fine metal oxides which meet the needs mentioned above and overcome the deficiencies of the prior art.

In accordance with this invention, a process for continuously preparing substantially spherical finely divided metal oxides having a specific surface area of less than about 100 m²/g from an oxygen containing reactant stream and at least one reactant stream selected from the group consisting of vaporous salts of silicon, titanium, aluminum, zirconium, iron and antimony is provided. The process basically comprises the steps of heating at least one of the reactant streams with plasma from a plasma jet generator to a temperature such that when combined the reactant streams have a temperature in the range of from about 700° C. to about 1200° C.; combining the reactant streams in a reaction zone for a period of from about 0.001 to about 1.0 second to produce an oxide product stream; quenching the oxide product stream with a quench gas which is injected into the oxide product stream after the stream exits the reaction zone and before any substantial cooling of the stream occurs; and wherein the oxygen containing reactant stream comprises from about 100% to about 105% of the stoichiometric amount of oxygen required based on the amount of the vaporous salt reaction stream and from about 10 to about 150 volume percent of a gaseous diluent which is inert under reaction conditions based on the amount of oxygen in said oxygen containing reactant stream.

It is, therefore, a general object of the present invention to provide an improved process for producing finely divided metal oxides.

Other and further objects, features and advantages of the present invention will be readily apparent to those skilled in the art upon a reading of the description of preferred embodiments which follows when taken in conjunction with the accompanying drawings.

### BRIEF DESCRIPTION OF THE DRAWINGS

FIG. 1 is a schematic flowsheet showing the process of the present invention.

FIG. 2 is a diagrammatic cross-sectional view of a reactor useful in the process of the present invention.

### DESCRIPTION OF PREFERRED EMBODIMENTS

In accordance with the process of the present invention, a finely divided metal oxide is produced having a specific surface area of less than about 100 m²/g, advantageously, a specific surface area of from about 70 m²/g to about 18 m²/g, a mean mass diameter of from about 0.08 microns to about 0.03 microns and optionally, a coating of aluminum oxide, phosphorus, and/or silicon oxide.

The particles of metal oxide produced by the present invention are substantially spherical in shape. While the particles have sizes within the range hereinbefore specified they also have a narrow specific surface area distribution. For the most preferred particles, it is most advantageous that at least about 80 percent of the particles by weight have a specific surface area within the range of from about 70 m²/g to about 18 m²/g. Preferably the range is from about 45 m²/g to about 28 m²/g.

Particle absorbency is usually expressed as a function of the amount of the uncoated particle present, and when expressed as an extinction coefficient, is substantially independent of a medium in which the particles are dispersed. However the extinction coefficient is preferably measured at various wave-lengths of light. Generally speaking, uncoated particles of the present invention when adequately dispersed have a minimum extinction coefficient of at least about 30 liters per gram of uncoated product per cm for radiation with a wave-length of 308 nm. Preferably the dispersion has a minimum extinction coefficient of at least about 35, and more preferably greater than about 40 liters per gram of uncoated product per cm at a wave length of 308 nm.

The products of the present invention can be used in a wide variety of plastics compositions such as in those used to form film material for covering substances such as foods or for use as agricultural films. Compositions based on polyolefins e.g., polyethylene or polypropylene have been found to be particularly useful. The amount of the product of this invention in a plastics composition will depend on its use, but usually the amount is from about 0.01% to about 5.0% of the weight of the composition. Plastics compositions containing the products of this invention can also be used to form articles which are subjected to outdoor exposure to UV light such as garden furniture.

According to this invention, it has been found that preheating at least one reactant in the plasma process prior to oxidizing metal or metalloid salts with gaseous oxygen to give finely divided oxides is advantageous. Preferably, the preheated gas stream is an oxygen containing reactant gas having about 100-105% of the stoichiometric amount of oxygen required based on the amount of metal or metalloid salt reacted therewith and additionally, from about 10 to about 150 volume percent of a gaseous diluent which is inert under reaction conditions based on the amount of oxygen in said oxygen containing reactant gas. Such an oxygen containing reactant gas stream can be obtained by combining oxygen and air in suitable proportions.

The plasma generator may be either a radio frequency (RF) or a DC arc type generator. Advantageously the plasma generator is a radio frequency plasma generator. Such a generator is preferred since the electrode material does not contaminate the material being heated.

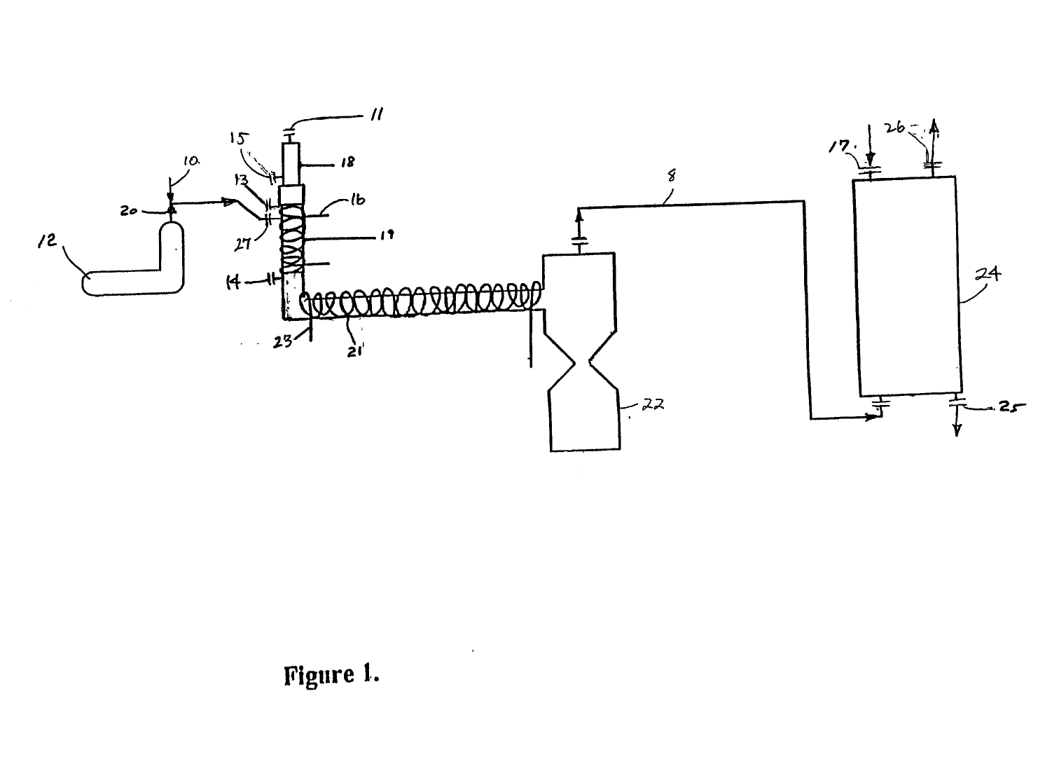

Referring to the drawings, in FIG. 1 an oxygen containing gas enters the plasma generator 18 at inlet connection 11. Optionally, aluminum chloride can enter the plasma generator 18 at inlet connection 15. Recycle gas containing chlorine enters reactor 19 at inlet connection 13. Metal halide is vaporized in vessel 12 and optionally subsequently mixed with aluminum chloride introduced into the conduit 20 by way of a conduit 10 connected thereto. The mixture of metal halide and aluminum chloride, if used, then enters the reactor 19 by way of inlet connection 27. The product of reactor 19 is mixed with oxygen containing quench gas at 14 prior to entering the product cooler 21. Cooling water removes heat from the reactor 19 and the product in cooler 21, by circulating in cooling coils 16 and 23, respectively. After cooling, the product gases are collected in vessel 22. The product gases from product cooler 21 are withdrawn from vessel 22 by way of a conduit 8 which conducts the product gases to scrubber 24. Scrubber solution enters the scrubber 24 by way of inlet connection 17. Spent solution from the scrubber is withdrawn for regeneration or disposal by way of outlet connection 25 and waste gases are removed from scrubber 24 by way of outlet connection 26.

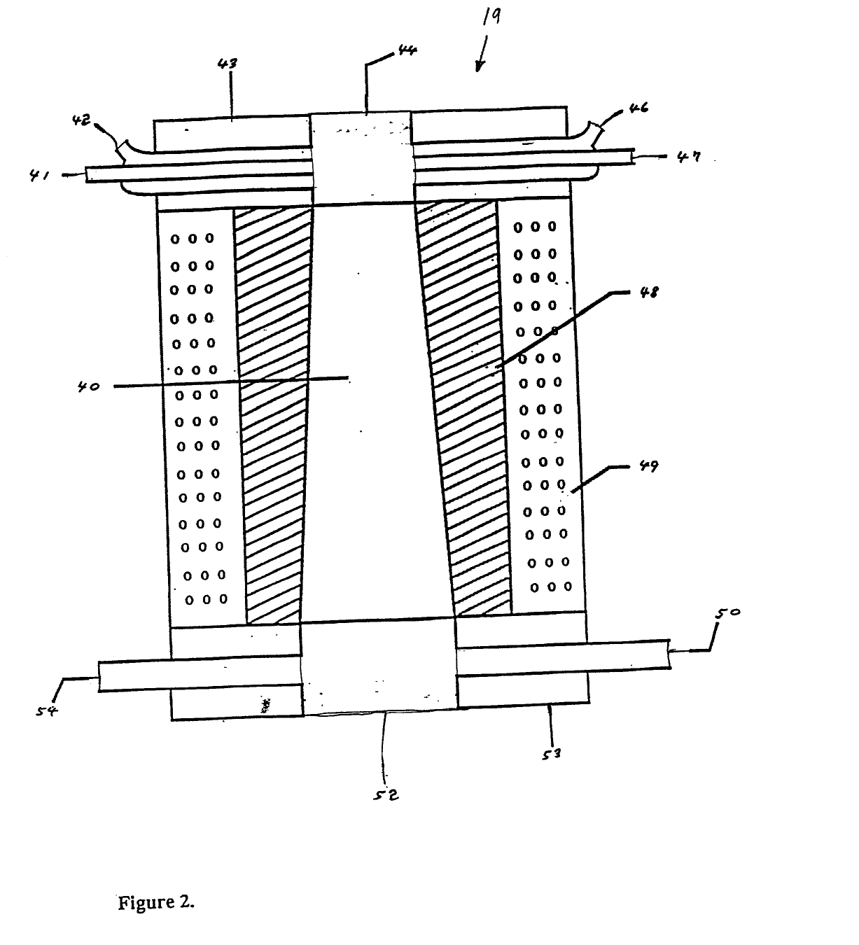

Referring to FIG. 2, a diagrammatic sectional view of the reactor 19 is shown. Metal halide enters the reactor 19 through conduits 41 and 47 which are connected to inlet connection 27 (not shown). Recycle gas containing chlorine enters the reactor through conduits 42 and 46 which are connected to the inlet connection 13 (not shown). Oxygen containing gas from the plasma generator 18 enters the reactor 19 through opening 44 in feed plate 43. A chlorine resistant and shock-resistant wall 48 forms the interior surfaces of the reactor 40. Optionally, the interior surfaces 40 may be porous. Low conductance insulation 49 forms the exterior of the reactor. Oxygen containing quench gas enters the reactor near its exit at 50 and 54 which are connected to inlet connection 14 (not shown). The product exits the reactor through opening 52 in feed plate 53 and is transported through product cooler 21 into product collection vessel 22.

Preferably, at least one of the reactants is separately admixed with a stream of heat-supplying plasma prior to introduction into the reactor. The two streams, one of which has been heated by the plasma stream, are brought together to bring the mixture of reactants to reaction temperature. If only one reactant is heated with a plasma stream, it must have sufficient excess heat to raise the reaction mixture to the reaction temperature.

For the purposes of this invention, it is desirable that reactant streams meet or converge at an angle with respect to each other of between about 25° and about 160° to form the reaction mixture, which is caused to flow along the path offering the least frictional resistance and producing the minimal change of momentum. It is noteworthy that a converging angle of about 90° gives efficient and trouble-free operation for a long period. Use of equipment in which the angle is varied slightly from the preferred angle does not result in a significant change in efficiency of the reaction. When the angle at which the two reactant streams impinge goes much below 90°, i.e., in the range of 25°-50°, it is found that the reactant streams will not intermix properly before entering the reaction zone unless the streams are flowing together with a sufficient momentum to assure turbulence. Thus, as a general rule, the smaller the angle of convergence, the higher should be the flow rate of the reactants. At these small angles, however, the problem of plugging is minimized and the particle size of the solid oxide product is generally smaller. If the angle of impingement is about 160°, efficiency of reaction is increased by reason of a higher order of mixing; but this increase in rate of reaction is accompanied by plugging problems. In view of the foregoing considerations, the preferred balance between high reaction and low plugging rates is obtained at practical reactant stream flow rates, when the angle of impingement of the two reactant streams is between 70° and 120°. Such an arrangement gives good mixing of the reactants without undue deposition of oxide particles on the walls of the reaction vessel.

The fluid used to form the plasma may be a gaseous material such as oxygen or an inert gas such as nitrogen, xenon, argon or helium. It is preferable that air is not used as the plasma heating the metal or metalloid salt. Either air or oxygen can be used to form the plasma used in heating the oxidizing gas.

Generally, the plasma should be heated to a temperature of about 3,000° C. to 12,000° C. prior to being admixed with the reactant. The quantity of reactant salt or salts which is admixed with a given amount of plasma depends, of course, on the desired reaction temperature and heat losses expected to occur before the reactants are admixed. In most operations, the quantity of plasma will be from about 3 to about 95% of the total gas mixture and preferably from about 5 to about 45% of the volume of the gas. The total volume of gases should be such that reactant streams flow together with turbulent mixing. It is understood that the inert gas used to form the plasma may be preheated by any practical means before being fed into the plasma generator and, likewise, the individual reactants may be preheated by such means as recycle of reaction zone effluents. Normally, such conventional heat exchange methods can raise either the reactants or the inert gas to temperature of up to about 600° C.

The temperature at which the oxidation reaction is initiated will, of course, depend upon the particular salt which is being oxidized. Initiation temperatures are well known for such salts as the halides of aluminum, silicon, titanium, antimony and boron. The actual temperature to which the reactants are raised may be well above the initiation temperatures in order to hasten the rate of reaction and to reflect particle size requirements. The reaction temperature in the reaction zone for titanium dioxide is from about 800° C. to about 2,000° C. In general, the reaction mixture should remain in the zone of reaction for a period of at least about 0.001 second and the residence need not be longer than about one second. Usually a residence of from about 0.02 to about 0.1 second is adequate and will give the product in the desired particle size.

The amount of oxygen used will be dependent upon the stoichiometry of the reaction. For practical results, at least a stoichiometric amount of oxygen should be present as based upon the salt being oxidized. It has in the past been thought desirable to have an excess of oxygen available during the reaction. Excesses of from about 5% to about 100% by volume have been recommended in the past. Using air, or other diluted oxygen mixtures, only the amount of air or such mixture required to give the stoichiometric amount of oxygen need be used. Advantageously, an excess of from about 10% to about 15% by volume of oxygen in the mixture is desirable to attain the benefits of the present invention. It is highly desirable to employ the dilution effect of the inert fluid, i.e., nitrogen, either pure, or as found in air, instead of using excess oxygen. It is also possible to use other inert gases such as recycled off-gas recovered from the reaction zone and freed of oxide product.

In the case of titanium dioxide where it may be desired to enhance the yield of the rutile crystalline form as against the anatase form, aluminum chloride may be fed into the reactant stream with the titantrium tetrachloride. The amount of aluminum chloride used for this purpose may vary over a wide range. In general, up to about 7% or, more preferably, from about 1.6% to about 4.7% by weight of the product oxide may be employed. Advantageously, a large proportion of titanium dioxide material produced by this method is found to have been in the optimum specific surface area range of from about 70 m²/g to about 18 m²/g.

An important step in the present invention that results in the finely-divided refractory oxides having a specific surface area of less than about 100 m²/g is the injection of a quench gas into the oxide product stream after the stream exits the reaction zone and before any substantial cooling of the stream occurs. Advantageously the quench gas is at a temperature lower than the oxide product stream. The quench gas used may vary depending upon the metal salt, however, it is advantageously air, oxygen, chlorine, recycled gas containing chlorine, or liquid chlorine. The metal or metalloid oxides produced using the aforesaid improvement have a fine, uniform particle size.

When titanium dioxide is formed, spherical particles of titanium dioxide having a specific surface area of less than about 100 m²/g and advantageously within the range of from about 70 m²/g to about 18 m²/g can be produced. Preferably the range is from about 45 m²/g to about 28 m²/g. While the titanium dioxide has specific surface areas within the specified range, the particles exhibit a narrow size distribution. It is most preferred that at least 80 percent of the titanium dioxide is within the range of from about 70 m²/g to about 18 m²/g.

The photoactivity of rutile pigments impairs the use of the pigments in many fields of application. For example, pressed laminate masses containing rutile pigment on melamine formaldehyde basis or pressed masses on the basis of urea- or melamine formaldehyde with worked-in rutile pigment show pronounced graying on exposure to light.

The present invention yields special benefits when used to produce the finely divided material discussed herein. It allows the chlorine content to be built up to a level that allows the gas to be recycled to a chlorination limit. Heating of the materials is accomplished without water being formed as would be if heating were by combustion of hydrocarbons. Recycle problems are substantially reduced or eliminated. The control of particle size requires both dilution and residence time be controlled. Residence time can not be too short or rutilization will be poor. Therefore, both must be controlled. Indirect heating of the reaction gases is not possible because chlorine will attack tubing (heat exchanger materials of construction). Heating with hydrocarbons would result in not only water formation but also excess HCl formulation.

The products of the present invention have the property of absorbing UV light and transmitting visible light. This means that the products are suitable in a wide variety of applications where it is important to maintain transparency of visible light while substantially preventing transmission of UV light. The products of the invention are of particular use in plastics compositions, particularly those used to form films.

Optionally, when titanium chloride is formed, aluminum chloride or phosphorous chloride nucleating agents in small amounts may be introduced in the vapor phase into the reactor. Phosphorous trichloride, pentachloride or oxychloride may be employed as the source of phosphorous chloride. The pigment base obtained in the reaction preferably contains from about 2 to about 4% by weight Al₂O₃ and from about 0.5 to about 3% P₂O₅.

Immediately after the reaction of titanium tetrachloride with oxygen the reaction mixture shows a temperature of more than about 1200° C. Usually this reaction mixture is quenched as fast as possible by blowing in a cold gas directly into the reaction mixture and thus cool it in a very short time until below about 700° C. This procedure leads, however, to a basic oxide body which only by a multiplicity of subsequent procedural steps (one or more post-treatments and post-calcination) leads to a product with satisfactory resistance to graying.

The products of the present invention have the property of absorbing UV light and transmitting visible light. This means that the products can find use in a wide variety of applications wherein it is important to maintain transparency of visible light while substantially preventing transmission of UV light to a surface. Cosmetics, suncreams, plastics film and wood coating and other coating compositions are just a small number of applications for the products.

The products of the invention can be in the dry state or sold or further handled in the form of a dispersion in either way or in another medium.

### EXAMPLE 1

This example shows the product which is obtained when oxygen is used to dilute the reaction product prior to cooling.

The TiO₂ formed in this reaction, at a calculated temperature of 1260° C. was evaluated at a bulk density of 0.20 g/cm³ and contained 45% rutile. The specific surface area for the TiO₂ product was 35.9 m²/g.

### EXAMPLE 2

This example shows the use of air as a diluent for the reaction product prior to cooling.

In an experiment similar to Example 1, except that 5.7 lbs./hr. of the O₂ were replaced by an equivalent molar flow rate of air, the TiO₂ product was evaluated at a bulk density of 0.19 g/cm³ and contained 31% rutile. The specific surface area for the TiO₂ product was 32.9 m²/g.

### EXAMPLE 3

This example shows the product which is obtained when chlorine is used as the diluent for the reaction product prior to cooling.

In a similar experiment to Example 1, except that 5.7 lbs./hr. of O₂ were replaced with an equivalent flow rate of Cl₂ pigment having a bulk density of 0.15 was obtained with 41% rutile. The specific surface area for the product was 31.5 m²/g.

Thus, the process of the present invention is well adapted to carry out the objects and attain the ends and advantages mentioned as well as those which are inherent therein. While numerous changes may be made by those skilled in the art, such changes are encompassed within the spirit of this invention as defined by the appended claims.

What is claimed is:

1. A process for continuously preparing substantially spherical finely divided metal oxides having a specific surface area of less than about 100 m²/g from an oxygen containing reactant and at least one reactant selected from the group consisting of vaporous salts of silicon, titanium, aluminum, zirconium, iron and antimony, comprising the steps of:
heating at least one of said reactants with plasma from a plasma jet generator to a temperature such that when combined the reactants have a temperature in the range of from about 700° C. to about 1200° C.;
combining said reactants in a reaction zone for a period of from about 0.001 to about 1.0 second to produce an oxide product;
quenching said oxide product with a quench gas which is injected into said oxide product stream after said stream exits said reaction zone and before any substantial cooling of said stream occurs; and
wherein said oxygen-containing reactant stream consists of from about 100 to about 105% of the stoichiometric amount of oxygen based on the vaporous salt and from about 10 to about 150%, based on oxygen, of a gaseous diluent which is inert under reaction conditions.

2. The process of claim 1 wherein the diluent gas contains oxygen.

3. The process of claim 2 wherein the diluent gas is air.

4. The process of claim 1 wherein the finely divided oxide has a specific surface area of from about 70 m²/g to about 18 m²/g.

5. The process of claim 4 wherein the finely divided oxide has a specific surface area of from about 45 m²/g to about 28 m²/g.

6. The process of claim 1 wherein the diluent gas is at a temperature lower than the oxide product stream.

7. The process of claim 1 wherein the oxygen-containing reactant stream is diluted with from about 0.2 to about 0.8 volume parts of air per volume part of oxygen.

8. The process of claim 1 wherein the streams of the two reactants are combined at an angle with respect to each other of from about 25° to about 160°.

9. The process of claim 1 wherein each reactant is separately admixed with gaseous fluid heated by means of a plasma generator prior to being combined with each other.

10. The process of claim 1 wherein the vaporous salt is titanium tetrachloride and the oxygen containing reactant is supplied as oxygen-enriched air.

11. The process of claim 1 wherein the gaseous fluid which is heated by means of the plasma generator is nitrogen.

12. The process of claim 10 wherein the oxygen-containing stream is oxygen diluted with from about 0.2 to about 0.8 volume part of air per volume part of oxygen.

13. The process of claim 10 wherein the gaseous diluent is recycled oxide-free off-gas from the reaction zone.

14. A particulate titanium dioxide material prepared by the process of claim 1 having a mean mass diameter of from about 0.01 to about 0.1 micron.

15. The particulate material according to claim 13 wherein at least about 80% by weight of the particles have a mean mass diameter of from about 0.08 to about 0.03 micron.

16. In a process for the production of finely-divided substantially spherical metal oxides having a specific surface area of less than about 100 m²/g which comprises oxidizing a metal halide with an oxidizing gas by introducing into one end of a reaction zone a hot stream of primary gas selected from an inert gas, the oxidizing gas or the metal halide, introducing a secondary gas selected from the oxidizing gas and the metal halide or mixtures thereof into the primary gas stream, the improvement comprising injecting a quench gas into the oxide product stream after said stream exits the reaction zone and before any substantial cooling of said stream occurs.

17. The process of claim 16 wherein the primary gas is oxygen and oxygen and metal halide comprise the secondary gas or gases.

18. The process of claim 16 wherein the primary gas is heated by passage through an electric arc.

19. A process for continuously preparing finely-divided substantially spherical refractory oxides having a specific surface area of less than about 100 m²/g from an oxygen-containing reactant and at least one reactant selected from the group consisting of vaporous salts of silicon, titanium, aluminum, zirconium, iron, and antimony, wherein the oxygen-containing reactant is heated by a plasma jet generator prior to contacting the vaporous salt, cooling the oxide product with quench gas prior to any substantial cooling of the oxide product, separating the cooled oxide product, quench gas and gases resulting from the reaction, and recovering the oxide product.

20. The process of claim 19 including the step of injecting PC1 solution into said plasma generator prior to introduction of the vaporous salt.

21. The process of claim 20 including the step of vaporizing the salt prior to contacting with the oxygen-containing reactant.

22. The process of claim 21 including the step of injecting AlCl₃ into the vaporous salt prior to contacting the oxygen-containing reactant.

23. The process of claim 19 including the step of injecting a chlorine-containing gas into the reactor after introduction of the oxygen-containing reactant and prior to the introduction of the vaporous salt.

24. The process of claim 19 wherein the quench gas is at a temperature below the temperature of the oxide product as it exits the reactor.

25. The process of claim 24 wherein the quench gas is a liquid.

26. The process of claim 25 wherein the quench gas is chlorine.

27. The process of claim 25 wherein the quench gas is chlorine-containing recycled gas.

28. The process of claim 1 wherein the plasma generator is a radio frequency plasma generator.

29. The process of claim 24 wherein the plasma generator is a radio frequency plasma generator.
